(19) United States
(12) Patent Application Publication
(10) Pub. No.: US 2026/0280794 A1
(43) Pub. Date: Sep. 17, 2026

(54) TIME SLOT CONFIGURATION METHOD AND APPARATUS, AND COMPUTER-READABLE STORAGE MEDIUM

(71) Applicant: ZTE CORPORATION, Shenzhen, Guangdong (CN)

(72) Inventors: Tong BAO, Shenzhen (CN); Yu XIN, Shenzhen (CN)

(21) Appl. No.: 19/165,071

(22) PCT Filed: Dec. 11, 2023
(86) PCT No.: PCT/CN2023/137887

§ 371 Date: Sep. 12, 2025

(30) Foreign Application Priority Data
May 12, 2023 (CN) 202310539605.7

(51) Int. Cl. H04L 5/00; H04W 72/0446

(52) U.S. Cl. CPC H04L 5/0048; H04W 72/0446

(57) ABSTRACT

Provided are a slot configuration method and apparatus, and a computer-readable storage medium. The slot configuration method includes: configuring a slot, where a number of symbols in the slot is a multiple of 15, the slot includes at least one pilot symbol and an even number of data symbols, and data transmitted by a pair of data symbols in the even number of data symbols in an order are identical.

### CROSS-REFERENCE TO RELATED APPLICATION(S)

The present disclosure is a national phase entry under 35 U.S. C 371 of International Application No. PCT/CN 2023/137887, filed on Dec. 11, 2023, the International Patent Application is filed based on Chinese Patent Application No. 202310539605.7, filed on May 12, 2023, and claims a priority to the Chinese Patent Application. The entire contents of the International Patent Application and the Chinese Patent Application are incorporated herein by reference.

### TECHNICAL FIELD

The present disclosure relates to the technical field of communications, and in particular, to a slot configuration method and apparatus, and a computer-readable storage medium.

### BACKGROUND

In the technical field of communications, a fourth generation long term evolution (LTE) system employs an orthogonal frequency division multiplexing (OFDM) technology, where time-frequency resources composed of sub-carriers and OFDM symbols form wireless physical time-frequency resources of the LTE system.

### SUMMARY

In one aspect, a slot configuration method is provided. The slot configuration method includes: configuring a slot; where a number of symbols in the slot is a multiple of 15, the slot includes at least one pilot symbol and an even number of data symbols, where data transmitted by a pair of data symbols in the even number of data symbols in an order are identical.

In another aspect, a slot configuration apparatus is provided. The slot configuration apparatus includes: a processing module. The processing module is configured to configure a slot; where a number of symbols in the slot is a multiple of 15, the slot includes at least one pilot symbol and an even number of data symbols, where data transmitted by a pair of data symbols in the even number of data symbols in an order are identical.

In some embodiments, the number of symbols in the slot is N times of 15, and N is a positive integer; in response to that N is an odd number, a number of the at least one pilot symbol is an odd number; in response to that N is an even number, a number of the at least one pilot symbol is an even number.

In some embodiments, in time domain, there are an even number of data symbols between two consecutive pilot symbols.

In some embodiments, in the time domain, there are at least two pilot symbols belonging to a same slot.

In some embodiments, in the time domain, there are at least two pilot symbols belonging to different slots.

In some embodiments, in the time domain, there are at least two consecutive pilot symbols that are adjacent in time domain positions.

In some embodiments, in response to that a number of pilot symbols in the slot is an even number, a number of pilot symbols being odd symbols in the slot is the same as a number of pilot symbols being even symbols in the slot;

in response to that the number of pilot symbols in the slot is an odd number, the number of pilot symbols being the odd symbols differs from the number of pilot symbols being the even symbols by 1, where an odd symbol is an odd-numbered symbol in the slot, an even symbol is an even-numbered symbol in the slot.

In some embodiments, among the at least one pilot symbol of the slot, a first pilot symbol is an odd symbol.

In some embodiments, in response to that a number of the at least one pilot symbol is an odd number, a last pilot symbol is an odd symbol; in response to that a number of the at least one pilot symbol is an even number, the last pilot symbol is an even symbol.

In some embodiments, in two consecutive pilot symbols, one pilot symbol is an odd symbol, and another pilot symbol is an even symbol.

In some embodiments, a pilot symbol includes two identical pilot sequences.

In some embodiments, a pilot sequence of the pilot symbol is a low peak-to-average power ratio modulation sequence; and a data sequence of a data symbol is a low peak-to-average power ratio modulation sequence.

In some embodiments, a low peak-to-average power ratio modulation sequence is a pi/2 binary phase shift keying (BPSK) sequence, or a pi/4 BPSK sequence.

In some embodiments, a time length of the slot is inversely proportional to a sub-carrier spacing; or the time length of the slot is 1 ms.

In some embodiments, the above-mentioned apparatus further includes a transmission module. The processing module is further configured to perform discrete Fourier transform on data in respective symbols in the slot to obtain frequency domain data; and perform oversampled inverse discrete Fourier transform on data obtained by resource mapping performed on the frequency domain data to obtain time domain data after resource mapping is performed on the frequency domain data in frequency domain; where the transmission module is configured to transmit data obtained by digital-to-analog conversion performed on the time domain data on a radio frequency link after digital-to-analog conversion is performed on the time domain data.

In yet another aspect, a communication apparatus is provided. The communication apparatus includes: a memory and a processor; where the memory and the processor are coupled; the memory is configured to store computer programs; the processor, upon performing the computer programs, implements the slot configuration method according to any one of the above-mentioned aspects or embodiments.

In yet another aspect, a computer-readable storage medium is provided. The computer-readable storage medium stores computer program instructions, where the computer program instructions, upon being executed by a processor, enable the processor to implement the slot configuration method according to any one of the above-mentioned aspects or embodiments.

In yet another aspect, a computer program product is provided. The computer program product includes computer program instructions, where the computer program instructions, upon being executed by a processor, enable the processor to implement the slot configuration method according to any one of the above-mentioned aspects or embodiments.

### BRIEF DESCRIPTION OF THE DRAWINGS

In order to more clearly illustrate the technical solutions in the present disclosure, the following will briefly introduce accompanying drawings required to be used in some embodiments of the present disclosure. Obviously, the accompanying drawings in the following description are merely accompanying drawings of some embodiments of the present disclosure. For ordinary technicians in the art, other accompanying drawings may also be obtained based on these accompanying drawings.

FIG. 1 is a schematic diagram of a communication network architecture according to some embodiments.

FIG. 2 is a schematic flowchart of a slot configuration method according to some embodiments.

FIG. 3 is a schematic diagram of a composition of symbols in a slot according to Embodiment I.

FIG. 4 is a schematic diagram of a composition of symbols in a slot according to Embodiment II.

FIG. 5 is a schematic diagram of a composition of symbols in a slot according to Embodiment III.

FIG. 6 is a schematic diagram of a composition of symbols in a slot according to Embodiment IV.

FIG. 7 is a schematic diagram of a composition of symbols in a slot according to Embodiment V.

FIG. 8 is a schematic diagram of a composition of symbols in a slot according to Embodiment VI.

FIG. 9 is a schematic diagram of a composition of symbols in a slot according to Embodiment VII.

FIG. 10 is a schematic flowchart of a signal processing according to Embodiment VIII.

FIG. 11 is a schematic diagram of a constitution of a slot configuration apparatus according to some embodiments.

FIG. 12 is a schematic diagram of a constitution of a communication apparatus according to some embodiments.

### DETAILED DESCRIPTION

The technical solutions in the present disclosure will be described clearly and completely below in conjunction with the accompanying drawings in the present disclosure. Obviously, the described embodiments are merely a part of the embodiments of the present disclosure rather than all embodiments. Based on the embodiments in the present disclosure, all other embodiments obtained by ordinary technicians in the art without creative work fall within the scope of protection of the present disclosure.

It should be noted that in the present disclosure, terms such as “exemplarily” or “for example” are used to provide examples, illustrations, or explanations. Any embodiment or design solution described in the present disclosure with wordings such as “exemplarily” or “for example” should not be illustrated as more preferred or advantageous embodiment or design solution over other embodiments or design solutions of the present disclosure. Specifically, the usage of the wordings such as “exemplarily” or “for example” is intended to present relevant concepts in a concrete way.

Hereinafter, terms such as “first” and “second” are used for descriptive purposes only, and should not be construed as indicating or implying relative importance or implicitly specifying a number of indicated technical features. Therefore, features defined with “first”, “second”, etc., may explicitly or implicitly include one or more such features.

In the description of the present disclosure, unless otherwise specified, “/” means an “or” relationship, for example, “A/B” may represent A or B. The term “and/or” in the description is merely an association relationship for describing related objects, which represents that there may be three relationships. For example, A and/or B may represent: only A; only B; or both A and B. In addition, “at least one” means a number of one or more, and “plurality” means a number of two or more.

To facilitate understanding of this solution, a brief introduction to professional terms involved in this solution is first provided.
1. Pilot symbol: a flag symbol in a slot for channel estimation. Since a signal may be impacted by interference and attenuation during transmission, a signal received at a receiving end is not exactly the same as the signal sent from a transmitting end. By introducing a certain number of pilot symbols, the receiving end may estimate a channel response based on received pilot symbols, thereby correcting and decoding received data symbols, thus to improve communication reliability and efficiency.
2. Data symbol: a symbol in a slot for transmitting actual data. A data symbol typically includes a plurality of bits, and may be implemented through different modulation schemes, such as amplitude modulation, frequency modulation, or phase modulation.

Currently, adding a cyclic prefix (CP) for an OFDM symbol is generally used to address a problem of multipath delay. However, the cyclic prefix does not carry any useful data, and may increase wireless physical time-frequency resource overhead during signal transmission, resulting in low utilization rate of time-frequency resources. Based on this, a slot configuration method is provided in the embodiments of the present disclosure. A number of symbols included in a slot configured in this method is a multiple of 15 (in some standards, a slot includes 14 symbols), so the slot has no cyclic prefix, fully utilizing the time-frequency resources. Additionally, in this method, two consecutive data symbols of a pair of ordered data symbols transmit identical data, allowing a preceding data symbol to act as a cyclic prefix for a subsequent data symbol, thus to avoid the problem of multipath delay during signal transmission. The symbols in the slot mentioned herein are OFDM symbols, for ease of description, these OFDM symbols are hereinafter referred to as symbols.

The technical solutions provided in the embodiments of the present disclosure may be applied to various communication systems, for example, a New Radio (NR) communication system using 5G communication technology, a future evolved system, or a multi-communication convergence system.

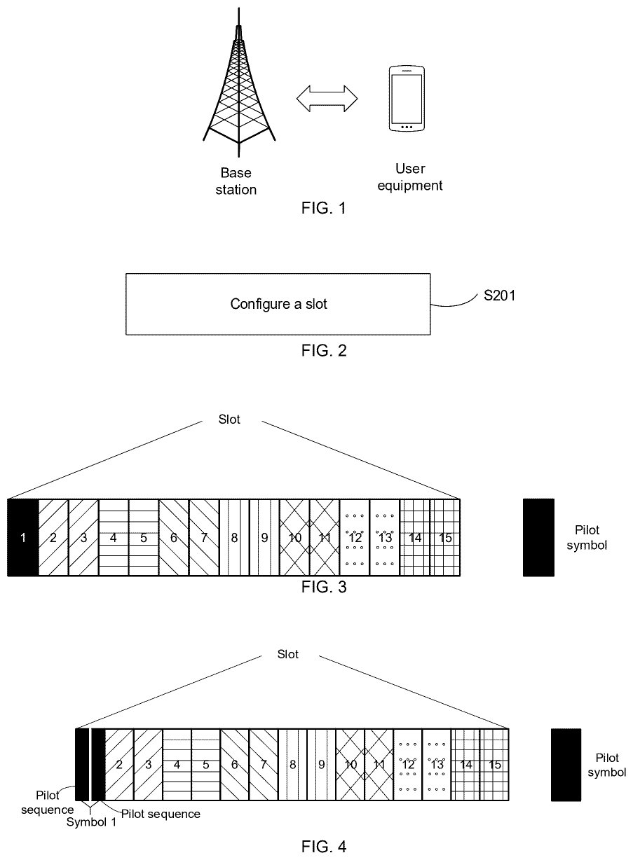

In an example, FIG. 1 is a schematic diagram of an architecture of a communication system according to some embodiments. As shown in FIG. 1, the communication system includes a base station and a user equipment (UE). The base station and the UE may be connected via a wired or wireless network. The wired or wireless network may include a router, a switch, or other devices facilitating communication between the base station and the UE, which is not limited in the embodiments of the present disclosure.

In some embodiments, the base station is configured to provide wireless access services for the UE. In some embodiments, one base station provides a service coverage area (also referred to as a cell). A UE entering this area may communicate with the base station via wireless signals, so as to receive wireless access services provided by the base station. Additionally, the service coverage area of the base station may be further divided into a near field and a far field, and the UE may be located within a range of the near field, or may be within a range of the far field.

In some embodiments, the base station may be an evolved NodeB (eNB), a next generation NodeB (gNB), a transmission receive point (TRP), a transmission point (TP), or some other types of access nodes. Based on a size of a provided service coverage area, a base station may be further classified into a macro base stations providing a macro cell, a micro base station providing a pico cell, and a femto base station providing a femto cell. With the continuous evolution of wireless communication technologies, future base stations may adopt other names.

In some embodiments, the UE may be a device with wireless transceiving functions, such as a mobile phone, a tablet, a wearable device, a vehicle-mounted device, an augmented reality (AR)/virtual reality (VR) device, a laptop, a ultra-mobile personal computer (UMPC), a netbook, or a personal digital assistant (PDA), etc. A type of user equipment is not limited in the embodiments of the present disclosure.

It should be understood that FIG. 1 is an exemplary structural diagram. The number of devices included in the communication system shown in FIG. 1 is not limited, for example, the number of base stations is not limited, and the number of UEs is not limited. Moreover, besides the devices shown in FIG. 1, the communication system shown in FIG. 1 may further include other devices, which is not limited herein.

FIG. 2 is a schematic flowchart of a slot configuration method according to some embodiments. In an example, the slot configuration method provided in the present disclosure may be applied to the communication system shown in FIG. 1. Embodiments of the present disclosure are described by taking a communication apparatus being an execution entity as an example. The communication apparatus may be the base station shown in FIG. 1, or a terminal (e.g., UE) shown in FIG. 1, which is not limited herein.

As shown in FIG. 2, the slot configuration method provided in the present disclosure may include the following steps.

In S201, a slot is configured.

A number of symbols in the slot is a multiple of 15; where the slot includes at least one pilot symbol and an even number of data symbols, and data transmitted by a pair of data symbols in the even number of data symbols in an order are identical.

It should be noted that in some LTE and 5G NR standards, a slot includes 14 symbols, which includes a cyclic prefix. However, in the slot provided in the embodiments of the present disclosure, the number of symbols is a multiple of 15, with no traditional cyclic prefix, thus reducing wireless physical time-frequency resource overhead. Moreover, in the embodiments of the present disclosure, data transmitted by two consecutive data symbols are identical. Transmitting the identical data may further improve signal gain. Additionally, for two symbols transmitting identical data, a preceding symbol may act as a cyclic prefix for a subsequent symbol, so as to avoid the problem of multipath delay during signal transmission.

In some embodiments, the number of symbols in the slot is N times of 15, where N is a positive integer. In response to that N is an odd number, a number of the at least one pilot symbol is an odd number; in response to that N is an even number, a number of the at least one pilot symbol is an even number.

It should be understood that the number of symbols in the slot being N times of 15 means that a number of symbols in a slot is 15×N. For example, in a case where N is 1, a slot includes 15 symbols; in a case where N is 2, a slot includes 30 symbols.

In some embodiments, in time domain, there are an even number of data symbols between two consecutive pilot symbols.

In some embodiments, in the time domain, there are at least two pilot symbols belonging to a same slot. Exemplarily, a slot includes two pilot symbols (i.e., a pilot symbol 1 and a pilot symbol 2); then these two pilot symbols belong to the same slot in the time domain.

In some embodiments, in the time domain, there are at least two pilot symbols belonging to different slots. Exemplarily, if a slot includes a pilot symbol 1, and a next slot includes a pilot symbol 2, then for these two slots, there are two pilot symbols belonging to different slots in the time domain.

In some embodiments, in the time domain, there are at least two consecutive pilot symbols that are adjacent in time domain positions. It should be understood that 0 data symbol may exist between two adjacent pilot symbols, and 0 is also an even number, which still satisfies the above-mentioned feature that there are an even number of data symbols between two consecutive pilot symbols.

In some embodiments, in response to that a number of pilot symbols in the slot is an even number, a number of pilot symbols being odd symbols in the slot is the same as a number of pilot symbols being even symbols in the slot. In response to that the number of pilot symbols in the slot is an odd number, the number of pilot symbols being the odd symbols differs from the number of pilot symbols being the even symbols by 1.

An odd symbol is an odd-numbered symbol in the slot, an even symbol is an even-numbered symbol in the slot. For example, a first (1^{st}) symbol in the slot is an odd symbol, a second (2^{nd}) symbol is an even symbol, a third (3^{rd}) symbol is an odd symbol, and so on.

In an example, taking the number of pilot symbols in a slot being P as an example, where P is a positive integer. In a case where P is an odd number, there are (P+1)/2 pilot symbols being odd symbols, and (P−1)/2 pilot symbols being even symbols in the slot. In a case where P is an even number, half of the pilot symbols in the slot are odd symbols, and another half of the pilot symbols in the slot are even symbols.

In some embodiments, among the at least one pilot symbol of the slot, a first pilot symbol is an odd symbol.

In some embodiments, in response to that a number of the at least one pilot symbol is an odd number, a last pilot symbol is an odd symbol; in response to that a number of the at least one pilot symbol is an even number, the last pilot symbol is an even symbol.

In some embodiments, in two consecutive pilot symbols, one pilot symbol is an odd symbol, and another pilot symbol is an even symbol.

Exemplarily, in a case where P is 1, a first pilot symbol in the slot is an odd symbol. In a case where P is 2, the first pilot symbol in the slot is an odd symbol, and a second pilot symbol is an even symbol. In a case where P is 3, the first pilot symbol in the slot is an odd symbol, the second pilot symbol is an even symbol, a third (last) pilot symbol is an odd symbol, and so on. In a case where P is an odd number, the last pilot symbol in the slot is an odd symbol; in a case where P is an even number, the last pilot symbol in the slot is an even symbol.

In some embodiments, a pilot symbol includes two identical pilot sequences.

In some embodiments, a pilot sequence of a pilot symbol is a low peak-to-average power ratio modulation sequence, and a data sequence of a data symbol is a low peak-to-average power ratio modulation sequence.

In some embodiments, a low peak-to-average power ratio modulation sequence is a pi/2 BPSK sequence, or a pi/4 BPSK sequence.

In some embodiments, a time length of the slot is inversely proportional to a sub-carrier spacing; or the time length of the slot is 1 ms. It should be understood that the time length of the slot is related to a sub-carrier spacing. The larger the sub-carrier spacing is, the shorter the time length of the slot is. For example, in a case where a sub-carrier spacing is 15 kHz, a time length of a slot is 1 ms. In a case where a sub-carrier spacing is 30 kHz, a time length of a slot is 0.5 ms. In a case where a sub-carrier spacing is 15× 2^{u} kHz, a time length of a slot is ½^{u} ms, where u is a positive integer.

In some embodiments, after the above-mentioned S201 is performed, the slot configuration method provided in the embodiments of the present disclosure may further include the following steps: Step a, discrete Fourier transform is performed on data in respective symbols in the slot to obtain frequency domain data. Step b, after resource mapping is performed on the frequency domain data in the frequency domain, oversampled inverse discrete Fourier transform is performed on data obtained by resource mapping performed on the frequency domain data to obtain time domain data. Step c, after digital-to-analog conversion is performed on the time domain data, data obtained by digital-to-analog conversion performed on the time domain data is transmitted on a radio frequency link.

The following provides a detailed illustration of a composition of symbols in a slot in combination with some embodiments and accompanying drawings in the specification.

Embodiment I

A number of symbols in a slot is N times of 15. The slot includes at least one pilot symbol and an even number of data symbols, data transmitted by a pair of data symbols in the even number of data symbols in an order are identical. Further, in a case where N is an odd number, a number of pilot symbols in the slot is an odd number, and a first pilot symbol in the slot is an odd symbol.

Taking FIG. 3 as an example, FIG. 3 is a schematic diagram of a composition of symbols in a slot according to Embodiment I. As shown in FIG. 3, taking N being 1 as an example, one slot includes 15 symbols, which are symbol 1, symbol 2, symbol 3, . . . , symbol 15 from left to right. It should be noted that orientation terms such as “left” and “right” used herein are described with reference to orientations in the accompanying drawings, and do not constitute limitations. The slot includes 1 pilot symbol and 14 data symbols, and two consecutive data symbols of a pair of ordered data symbols transmit identical data. In the accompanying drawings of the embodiments of the present disclosure, a solid black rectangle represents a pilot symbol, and other rectangles represent data symbols. Additionally, in one slot, rectangles with the identical shading represent data symbols transmitting identical data. It should be understood that for ease of description in the accompanying drawings, data symbols represented by rectangles with the identical shading may exist in different slots. For example, in FIG. 8, symbol 2 and symbol 3 in slot 1 have the identical shading as symbol 2 and symbol 3 in slot 2, but this situation does not mean that data symbols with the identical shading respectively in slot 1 and slot 2 transmit identical data.

For example, as shown in FIG. 3, the pilot symbol is symbol 1, i.e., an odd symbol. The other 14 data symbols occupy symbols 2-15, where data symbol 2 and data symbol 3 transmit identical data, data symbol 4 and data symbol 5 transmit identical data, . . . , and so on, data symbol 14 and data symbol 15 transmit identical data.

### Embodiment II

A number of symbols in a slot is N times of 15. The slot includes at least one pilot symbol and an even number of data symbols, data transmitted by a pair of data symbols in the even number of data symbols in an order are identical. Further, in a case where N is an odd number, a number of pilot symbols in the slot is an odd number, and a first pilot symbol in the slot is an odd symbol. A pilot symbol includes two identical pilot sequences.

Taking FIG. 4 as an example, FIG. 4 is a schematic diagram of a composition of symbols in a slot according to Embodiment II. As shown in FIG. 4, taking N being 1 as an example, one slot includes 15 symbols, which are symbol 1, symbol 2, symbol 3, . . . , symbol 15 from left to right. The slot includes 1 pilot symbol and 14 data symbols, and two consecutive data symbols of a pair of ordered data symbols transmit identical data.

For example, as shown in FIG. 4, the pilot symbol is symbol 1, i.e., an odd symbol. Additionally, the pilot symbol 1 includes two identical pilot sequences. The other 14 data symbols occupy symbols 2-15, where data symbol 2 and data symbol 3 transmit identical data, data symbol 4 and data symbol 5 transmit identical data, . . . , and so on, data symbol 14 and data symbol 15 transmit identical data.

### Embodiment III

A number of symbols in a slot is N times of 15. The slot includes at least one pilot symbol and an even number of data symbols, data transmitted by a pair of data symbols in the even number of data symbols in an order are identical. Further, in a case where N is an odd number, the number of pilot symbols in the slot is an odd number, a first pilot symbol in the slot is an odd symbol, and a last pilot symbol is an odd symbol. Additionally, among any two consecutive pilot symbols, one pilot symbol is an odd symbol, and another pilot symbol is an even symbol. In time domain, there are at least two pilot symbols belonging to a same slot.

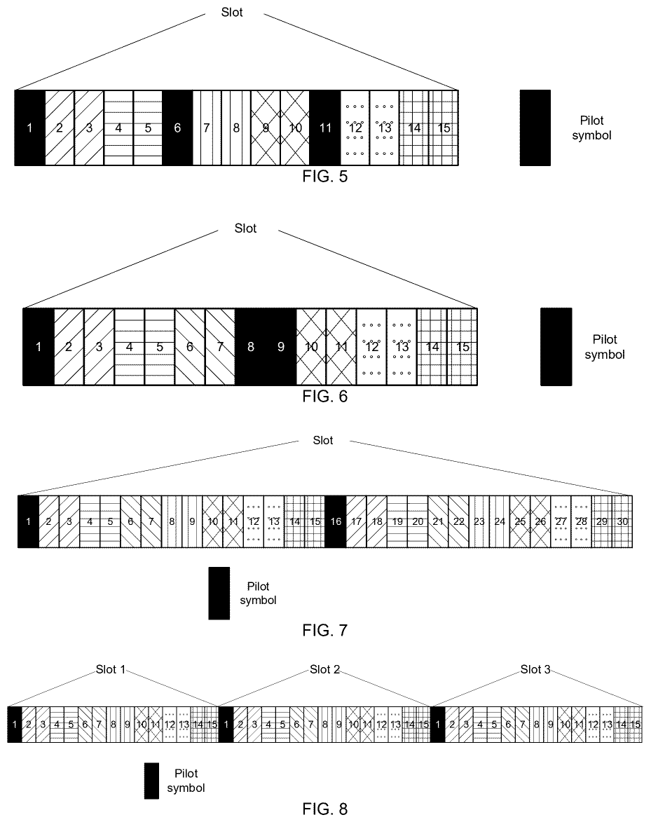

Taking FIG. 5 as an example, FIG. 5 is a schematic diagram of a composition of symbols in a slot according to Embodiment III. As shown in FIG. 5, taking N being 1 and a number of pilot symbols being 3 as an example, a slot includes 15 symbols, which are symbol 1, symbol 2, symbol 3, . . . , symbol 15 from left to right. The slot includes 3 pilot symbols and 12 data symbols, and two consecutive data symbols of a pair of ordered data symbols transmit identical data.

For example, as shown in FIG. 5, the pilot symbols are symbol 1, symbol 6, and symbol 11, i.e., a first pilot symbol is an odd symbol, a second pilot symbol is an even symbol, and a third (last) pilot symbol is an odd symbol. Additionally, it can be seen that among any two consecutive pilot symbols, symbol 1 is an odd symbol, symbol 6 is an even symbol, and symbol 11 is an odd symbol. The other 12 data symbols occupy symbols 2-5, symbols 7-10, and symbols 12-15, respectively, where data symbol 2 and data symbol 3 transmit identical data, data symbol 4 and data symbol 5 transmit identical data; data symbol 7 and data symbol 8 transmit identical data, data symbol 9 and data symbol 10 transmit identical data; data symbol 12 and data symbol 13 transmit identical data, data symbol 14 and data symbol 15 transmit identical data.

There are 4 data symbols (symbols 2-5) between the pilot symbol 1 and the pilot symbol 6, and 4 data symbols (symbols 7-10) between the pilot symbol 6 and the pilot symbol 11. These three pilot symbols belong to the same slot in the time domain.

### Embodiment IV

A number of symbols in a slot is N times of 15. The slot includes at least one pilot symbol and an even number of data symbols, data transmitted by a pair of data symbols in the even number of data symbols in an order are identical. Further, in a case where N is an odd number, the number of pilot symbols in the slot is an odd number, a first pilot symbol in the slot is an odd symbol, and a last pilot symbol is an odd symbol. Additionally, among any two consecutive pilot symbols, one pilot symbol is an odd symbol, and another pilot symbol is an even symbol. In the time domain, there are at least two consecutive pilot symbols that are adjacent in time domain positions.

Taking FIG. 6 as an example, FIG. 6 is a schematic diagram of a composition of symbols in a slot according to Embodiment IV. As shown in FIG. 6, taking N being 1 and a number of pilot symbols being 3 as an example, a slot includes 15 symbols, which are symbol 1, symbol 2, symbol 3, . . . , symbol 15 from left to right. The slot includes 3 pilot symbols and 12 data symbols, and two consecutive data symbols of a pair of ordered data symbols transmit identical data.

For example, as shown in FIG. 6, the pilot symbols are symbol 1, symbol 8, and symbol 9, i.e., a first pilot symbol is an odd symbol, a second pilot symbol is an even symbol, and a third (last) pilot symbol is an odd symbol. Additionally, the pilot symbol 8 and the pilot symbol 9 are adjacent in time domain positions. The other 12 data symbols occupy symbols 2-7 and symbols 10-15, respectively, where data symbol 2 and data symbol 3 transmit identical data, data symbol 4 and data symbol 5 transmit identical data, data symbol 6 and data symbol 7 transmit identical data, data symbol 10 and data symbol 11 transmit identical data, data symbol 12 and data symbol 13 transmit identical data, data symbol 14 and data symbol 15 transmit identical data.

### Embodiment V

A number of symbols in a slot is N times of 15. The slot includes at least one pilot symbol and an even number of data symbols, data transmitted by a pair of data symbols in the even number of data symbols in an order are identical. Further, in a case where N is an even number, the number of pilot symbols in the slot is an even number, a first pilot symbol in the slot is an odd symbol, and a last pilot symbol is an even symbol. Additionally, among any two consecutive pilot symbols, one pilot symbol is an odd symbol, and another pilot symbol is an even symbol.

Taking FIG. 7 as an example, FIG. 7 is a schematic diagram of a composition of symbols in a slot according to Embodiment V. As shown in FIG. 7, taking N being 2 and a number of pilot symbols being 2 as an example, a slot includes 30 symbols, which are symbol 1, symbol 2, symbol 3, . . . , symbol 30 from left to right. The slot includes 2 pilot symbols and 28 data symbols, and two consecutive data symbols of a pair of ordered data symbols transmit identical data.

For example, as shown in FIG. 7, the pilot symbols are symbol 1 and symbol 16, i.e., the first pilot symbol is an odd symbol, and the second (last) pilot symbol is an even symbol. There are 14 data symbols (symbols 2-15) between the pilot symbol 1 and the pilot symbol 16, where data symbol 2 and data symbol 3 transmit identical data, data symbol 4 and data symbol 5 transmit identical data, . . . , and so on, data symbol 29 and data symbol 30 transmit identical data.

### Embodiment VI

A number of symbols in a slot is N times of 15. The slot includes at least one pilot symbol and an even number of data symbols, data transmitted by a pair of data symbols in the even number of data symbols in an order are identical. Further, in a case where N is an odd number, a number of pilot symbols in the slot is an odd number, and a first pilot symbol in the slot is an odd symbol. Additionally, in the time domain, there are at least two pilot symbols belonging to different slots.

Taking FIG. 8 as an example, FIG. 8 is a schematic diagram of a composition of symbols in a slot according to Embodiment VI. As shown in FIG. 8, taking N being 1 and there being 3 slots with a number of pilot symbols in each slot being 1 as an example, one slot includes 15 symbols, which are symbol 1, symbol 2, symbol 3, . . . , symbol 15 from left to right. Any slot includes 1 pilot symbol and 14 data symbols, and two consecutive data symbols of a pair of ordered data symbols transmit identical data.

For example, as shown in FIG. 8, a first symbol (symbol 1) in each slot is a pilot symbol, which means that any two pilot symbols belong to different slots. There are 14 data symbols between a pilot symbol 1 in slot 1 and a pilot symbol 1 in slot 2, and 14 data symbols between the pilot symbol 1 in slot 2 and a pilot symbol 1 in slot 3. In each slot, data symbol 2 and data symbol 3 transmit identical data, data symbol 4 and data symbol 5 transmit identical data, . . . , and so on, data symbol 14 and data symbol 15 transmit identical data.

### Embodiment VII

A number of symbols in a slot is N times of 15. The slot includes at least one pilot symbol and an even number of data symbols, data transmitted by a pair of data symbols in the even number of data symbols in an order are identical. Further, in a case where N is an odd number, a number of pilot symbols in the slot is an odd number, and a first pilot symbol in the slot is an odd symbol. Additionally, in the time domain, there are at least two consecutive pilot symbols that are adjacent in time domain positions, and there are at least two pilot symbols belonging to the same slot.

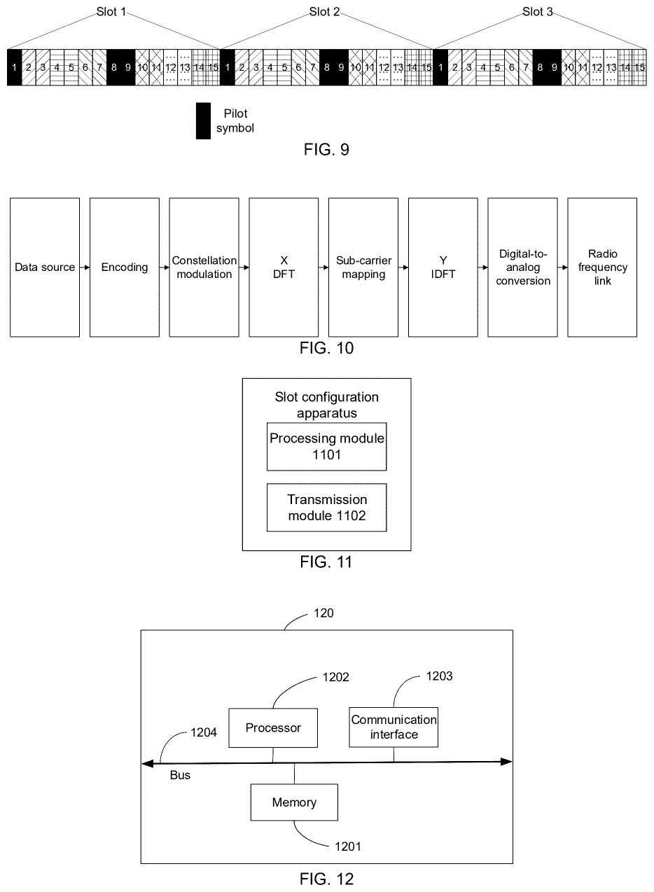

Taking FIG. 9 as an example, FIG. 9 is a schematic diagram of a composition of symbols in a slot according to Embodiment VII. As shown in FIG. 9, taking N being 1 and there being 3 slots with a number of pilot symbols in each slot being 3 as an example, one slot includes 15 symbols, which are symbol 1, symbol 2, symbol 3, . . . , symbol 15 from left to right. Any slot includes 3 pilot symbols and 12 data symbols, and two consecutive data symbols of a pair of ordered data symbols transmit identical data.

For example, as shown in FIG. 9, in each slot, symbol 1, symbol 8, and symbol 9 are pilot symbols, which means that there are two consecutive pilot symbols (symbol 8 and symbol 9) that are adjacent in time domain positions. Additionally, in each slot, a pilot symbol 8 and a pilot symbol 9 are adjacent in time domain positions. In each slot, there are 6 data symbols between a pilot symbol 1 and a pilot symbol 8, 0 data symbols between pilot symbol 8 and pilot symbol 9, and 6 data symbols between the pilot symbol 9 and a pilot symbol 1 of a next slot. In each slot, data symbol 2 and data symbol 3 transmit identical data, data symbol 4 and data symbol 5 transmit identical data, . . . , and so on, data symbol 14 and data symbol 15 transmit identical data.

### Embodiment VIII

Step a, discrete Fourier transform is performed on data in respective symbols in the slot to obtain frequency domain data. Step b, after resource mapping is performed on the frequency domain data in the frequency domain, oversampled inverse discrete Fourier transform is performed on data obtained by resource mapping performed on the frequency domain data to obtain time domain data. Step c, after digital-to-analog conversion is performed on the time domain data, data obtained by digital-to-analog conversion performed on the time domain data is transmitted on a radio frequency link.

Taking FIG. 10 as an example, FIG. 10 is a schematic flowchart of signal processing according to Embodiment VIII. In FIG. 10, encoding and a constellation modulation is performed on a set of binary bit data sequences, then modulated time domain data is generated. Then, X-point discrete Fourier transform (DFT) processing is performed, so as to transforms the modulated time domain data into parallel frequency domain data. A value of X is a length of the time domain data (i.e., a number of data/symbols). Then, sub-carrier mapping is performed on the frequency domain data, where data 0 is placed at positions of a portion of sub-carriers to achieve oversampling. Then, Y-point inverse discrete Fourier transform (IDFT) processing is performed, so as to transforms data obtained after the sub-carrier mapping is performed on the frequency domain data into serial time domain data in the time domain. Y>X, so the above inverse discrete Fourier transform is an oversampled inverse discrete Fourier transform. Finally, after digital-to-analog conversion is performed on the processed time domain data, the obtained data is transmitted on a radio frequency (RF) link.

In the slot configuration method provided in the embodiments of the present disclosure, the number of symbols included in a slot configured in this method is a multiple of 15, thus there is no traditional cyclic prefix in the slot, reducing wireless physical time-frequency resource overhead, and improving the utilization rate of time-frequency resources. Moreover, in this method, data transmitted by two consecutive data symbols are identical. Transmitting the identical data may not only further improve signal gain, but also avoiding the problem of multipath delay during signal transmission since a preceding symbol acting as a cyclic prefix for a subsequent symbol for two symbols transmitting identical data.

It may be understood that to implement the above-mentioned functions, a slot configuration apparatus (which may be the above-mentioned base station) includes corresponding hardware structures and/or software modules for performing various functions. Those skilled in the art should easily realize that the present disclosure may be implemented in the form of hardware or a combination of hardware and computer software in combination with algorithms and steps described in the embodiments of the present disclosure. Whether a certain function is implemented by hardware or by computer software driving hardware depends on the specific application and design constraint conditions of the technical solutions. A professional technician may use different methods to implement the described functions for each specific application, but such implementation should not be considered beyond the scope of the present disclosure.

The slot configuration apparatus may be divided into functional modules according to the above-mentioned method embodiments in the embodiments of the present disclosure. For example, each functional module may be divided corresponding to each function, or two or more functions may be integrated into one functional module. The above-mentioned integrated module may be implemented in the form of hardware or in the form of software. It should be noted that the division for the modules in the embodiments of the present disclosure is illustrated, which is only a logical functional division, and there may be other division manners in actual implementation. The following is illustrated by taking an example of a division of each functional module corresponding to each function.

FIG. 11 is a schematic structural diagram of a slot configuration apparatus according to some embodiments. The slot configuration apparatus may perform the slot configuration method provided in the above-mentioned method embodiments. As shown in FIG. 11, the slot configuration apparatus includes: a processing module 1101.

The processing module 1101 is configured to configure a slot; where a number of symbols in the slot is a multiple of 15; the slot includes at least one pilot symbol and an even number of data symbols; where data transmitted by a pair of data symbols in the even number of data symbols in an order are identical.

In some embodiments, the number of symbols in the slot is N times of 15; in response to that N is an odd number, a number of the at least one pilot symbol is an odd number; in response to that N is an even number, a number of the at least one pilot symbol is an even number.

In some embodiments, in time domain, there are an even number of data symbols between two consecutive pilot symbols.

In some embodiments, in the time domain, there are at least two pilot symbols belonging to a same slot.

In some embodiments, in the time domain, there are at least two pilot symbols belonging to different slots.

In some embodiments, in the time domain, there are at least two consecutive pilot symbols that are adjacent in time domain positions.

In some embodiments, in response to that a number of pilot symbols in the slot is an even number, a number of pilot symbols being odd symbols in the slot is the same as a number of pilot symbols being even symbols in the slot; in response to that the number of pilot symbols in the slot is an odd number, the number of pilot symbols being the odd symbols differs from the number of pilot symbols being the even symbols by 1, where an odd symbol is an odd-numbered symbol in the slot, an even symbol is an even-numbered symbol in the slot.

In some embodiments, among the at least one pilot symbol of the slot, a first pilot symbol is an odd symbol.

In some embodiments, in response to that a number of the at least one pilot symbol is an odd number, a last pilot symbol is an odd symbol; in response to that a number of the at least one pilot symbol is an even number, the last pilot symbol is an even symbol.

In some embodiments, in two consecutive pilot symbols, one pilot symbol is an odd symbol, and another pilot symbol is an even symbol.

In some embodiments, a pilot symbol includes two identical pilot sequences.

In some embodiments, a pilot sequence of the pilot symbol is a low peak-to-average power ratio modulation sequence; and a data sequence of a data symbol is a low peak-to-average power ratio modulation sequence.

In some embodiments, a low peak-to-average power ratio modulation sequence is a pi/2 BPSK sequence, or a pi/4 BPSK sequence.

In some embodiments, a time length of the slot is inversely proportional to a sub-carrier spacing; or the time length of the slot is 1 ms.

In some embodiments, the above-mentioned apparatus further includes a transmission module 1102. The processing module 1101 is further configured to perform discrete Fourier transform on data in respective symbols in the slot to obtain frequency domain data; and perform oversampled inverse discrete Fourier transform on data obtained by resource mapping performed on the frequency domain data to obtain time domain data after resource mapping is performed on the frequency domain data in frequency domain; where the transmission module 1102 is configured to transmit data obtained by digital-to-analog conversion performed on the time domain data on a radio frequency link after digital-to-analog conversion is performed on the time domain data.

In a case where the functions of the above-mentioned integrated modules are implemented in the form of hardware, another structure of a communication apparatus involved in the above-mentioned embodiments is provided in the embodiments of the present disclosure. As shown in FIG. 12, the communication apparatus 120 includes: a memory 1201, a processor 1202, a communication interface 1203, and a bus 1204.

The memory 1201 may be a read-only memory (ROM) or other types of static storage devices that are capable of storing static information and instructions, a random access memory (RAM), or other types of dynamic storage devices that are capable of storing information and instructions, or may be an electrically erasable programmable read-only memory (EEPROM), a magnetic disk storage medium or any other magnetic storage devices, or any other medium that are capable of being used to carry or store desired program codes with instructions or data and can be accessed by a computer, which is not limited thereto.

The processor 1202 may be an exemplary logic block, module, and circuit for implement or perform various embodiments described in the present disclosure. The processor 1202 may be a central processing unit, a general-purpose processor, a digital signal processor, an application-specific integrated circuit, a field programmable gate array, other programmable logic devices, transistor logic devices, hardware components, or any combination thereof. The processor 1202 may implement or perform various exemplary logical blocks, modules, and circuits described in conjunction with the embodiments of the present disclosure. The processor 1202 may also be a combination for implementing computing functions, for example, a combination including one or more microprocessors, a combination of a DSP (digital signal processor) and a microprocessor, or the like.

The communication interface 1203 is configured to connect to other devices via a communication network. The communication network may be an Ethernet, a radio access network, a wireless local area network (WLAN), or the like.

In an embodiment, the memory 1201 may exist independently from the processor 1202, and the memory 1201 may be connected to the processor 1202 through the bus 1204, which is used for storing instructions or program codes. When the processor 1202 invokes and executes the instructions or program codes stored in the memory 1201, the processor 1202 may implement the slot configuration method provided in the embodiments of the present disclosure.

In an embodiment, the memory 1201 may also be integrated with the processor 1202.

The bus 1204 may be an extended industry standard architecture (EISA) bus, or the like. The bus 1204 may be classified into an address bus, a data bus, a control bus, etc. For the convenience of representation, only one thick solid line is used in FIG. 12 for representing the bus 1204, but it does not mean that there is only one bus or one type of bus.

A computer-readable storage medium (for example, a non-transitory computer-readable storage medium) is provided in some embodiments of the present disclosure. The computer-readable storage medium stores computer program instructions, and when the computer program instructions are run on a computer, the computer is enabled to perform the slot configuration method described in any one of the above-mentioned embodiments.

Exemplarily, the above-mentioned computer-readable storage medium may include, but not limited to: a magnetic storage device (e.g., a hard disk, a floppy disk, or a magnetic tape, etc.), an optical disk (e.g., a compact disk (CD), a digital versatile disk (DVD), etc.), a smart card and a flash memory device (e.g., an erasable programmable read-only memory (EPROM), a card, a stick or a key driver, etc.). The various computer-readable storage media described in the present disclosure may represent one or more devices and/or other machine-readable storage media for storing information. The term “machine-readable storage medium” may include, but not limited to, a wireless channel and various other medium capable of storing, containing, and/or carrying instructions and/or data.

A computer program product including instructions is provided in the embodiments of the present disclosure, when the computer program product is run on a computer, the computer is enabled to perform the slot configuration method as described in any one of the above-mentioned embodiments.

The above descriptions are merely some implementations of the present disclosure, but the scope of protection of the present disclosure is not limited thereto; any changes or replacements within the technical scope disclosed in the present disclosure should be covered by the protection scope of the present disclosure. Therefore, the protection scope of the present disclosure shall be subject to the protection scope of the claims.

What is claimed is:

1. A slot configuration method, wherein the method comprises:
configuring a slot, wherein a number of symbols in the slot is a multiple of 15, the slot comprises at least one pilot symbol and an even number of data symbols, wherein data transmitted by a pair of data symbols in the even number of data symbols in an order are identical.

2. The method according to claim 1, wherein the number of symbols in the slot is N times of 15, and N is a positive integer, wherein
in response to that N is an odd number, a number of the at least one pilot symbol is an odd number;
in response to that N is an even number, a number of the at least one pilot symbol is an even number.

3. The method according to claim 1, wherein in time domain, there are an even number of data symbols between two consecutive pilot symbols.

4. The method according to claim 3, wherein in the time domain, there are at least two pilot symbols belonging to a same slot.

5. The method according to claim 3, wherein in the time domain, there are at least two pilot symbols belonging to different slots.

6. The method according to claim 3, wherein in the time domain, there are at least two consecutive pilot symbols that are adjacent in time domain positions.

7. The method according to claim 1, wherein in response to that a number of pilot symbols in the slot is an even number, a number of pilot symbols being odd symbols in the slot is the same as a number of pilot symbols being even symbols in the slot;
in response to that the number of pilot symbols in the slot is an odd number, the number of pilot symbols being the odd symbols differs from the number of pilot symbols being the even symbols by 1, wherein an odd symbol is an odd-numbered symbol in the slot, an even symbol is an even-numbered symbol in the slot.

8. The method according to claim 1, wherein among the at least one pilot symbol of the slot, a first pilot symbol is an odd symbol.

9. The method according to claim 8, wherein in response to that a number of the at least one pilot symbol is an odd number, a last pilot symbol is an odd symbol;
in response to that a number of the at least one pilot symbol is an even number, the last pilot symbol is an even symbol.

10. The method according to claim 9, wherein in two consecutive pilot symbols, one pilot symbol is an odd symbol, and another pilot symbol is an even symbol.

11. The method according to claim 1, wherein a pilot symbol of the at least one pilot symbol comprises two identical pilot sequences.

12. The method according to claim 11, wherein a pilot sequence of the pilot symbol is a low peak-to-average power ratio modulation sequence; a data sequence of a data symbol is a low peak-to-average power ratio modulation sequence.

13. The method according to claim 12, wherein a low peak-to-average power ratio modulation sequence is a pi/2 binary phase shift keying (BPSK) sequence, or a pi/4 BPSK sequence.

14. The method according to claim 1, wherein a time length of the slot is inversely proportional to a sub-carrier spacing; or a time length of the slot is 1 ms.

15. The method according to claim 1, wherein the method further comprises:
performing discrete Fourier transform on data in respective symbols in the slot to obtain frequency domain data;
performing oversampled inverse discrete Fourier transform on data obtained by resource mapping performed on the frequency domain data to obtain time domain data after resource mapping is performed on the frequency domain data in frequency domain; and
transmitting data obtained by digital-to-analog conversion performed on the time domain data on a radio frequency link after digital-to-analog conversion is performed on the time domain data.

16. A slot configuration apparatus, wherein the apparatus comprises:
a processing module, configured to configure a slot, wherein a number of symbols in the slot is a multiple of 15, the slot comprises at least one pilot symbol and an even number of data symbols, wherein data transmitted by a pair of data symbols in the even number of data symbols in an order are identical.

17. A communication apparatus, comprising: a processor and a memory configured to store executable instructions for the processor;
wherein the processor is configured to perform the instructions, to cause the communication apparatus to implement the slot configuration method according to claim 1.

18. A non-transitory computer-readable storage medium, wherein the computer-readable storage medium stores computer instructions that, upon running on a communication apparatus, cause the communication apparatus to implement the slot configuration method according to claim 1.
